(19) United States
(12) Patent Application Publication
(10) Pub. No.: US 2025/0376041 A1
(43) Pub. Date: Dec. 11, 2025

(54) CURRENT COLLECTION SHOE APPARATUS

(71) Applicant: First Greater Western Limited, Swindon (GB)

(72) Inventors: Julian Guy Fletcher, Leamington Spa, Warwickshire (GB); Daniel Robert Jones, The Wern, Bersham (GB)

(21) Appl. No.: 18/878,019

(22) PCT Filed: Jun. 15, 2023
(86) PCT No.: PCT/GB2023/051575

§ 371 Date: Dec. 21, 2024

(30) Foreign Application Priority Data
Jun. 22, 2022 (GB) 2209176.3
Jul. 1, 2022 (GB) 2209686.1

(51) Int. Cl. B60L 5/39

(52) U.S. Cl. CPC B60L 5/39; B60L 2200/26

(57) ABSTRACT

A rail vehicle current collection shoe apparatus comprises a current collection shoe for collecting current from a trackside charging contact; and an actuator configured to move the current collection shoe between a retracted position and a deployed position. The actuator is mechanically linked to the current collection shoe via a first support member and a second support member, wherein the second support member is connected to the first support member by a frangible joint. The rail vehicle current collection shoe apparatus is configured to break at the frangible joint responsive to a shear force being applied to the current collection shoe and/or the first support member, the applied shear force exceeding a threshold shear force.

### FIELD OF INVENTION

The present invention relates to shoe gear for charging electric vehicles, and in particular battery electric rail vehicles.

### BACKGROUND

Ongoing electrification of rail vehicles is a key part of de-carbonising the rail transport sector. However, many electric rail vehicles require a permanent connection to a high voltage power supply infrastructure, for example catenary or electrified “third rails”. Such infrastructure is highly expensive, and its installation is not possible in all locations.

One known solution is to provide battery-powered rail vehicles. Such vehicles do not require additional infrastructure along the whole length of a route. Instead, on-board batteries are charged at predetermined locations along the route to ensure that the vehicle has sufficient stored energy to traverse the route.

Patent application publication WO 2019229479 A1 describes a charging system for a battery electric rail vehicle including a charging rail dimensioned to be fully coverable by a train carriage; a power supply for charging an electric train battery, the power supply being configured to selectively supply a charging current to the charging rail; and, a sensor apparatus configured to detect the position and/or movement of a train carriage over the charging rail; in which the sensor is connected to the power supply such that the charging current is only supplied to the charging rail when the train carriage at least partially covers the charging rail.

Patent publication US 2018/141452 A1 describes a charging arrangement for a battery-electric tram, in which a deployable contact is lowered from the tram to connect with a power supply contact in the ground. The contact is only lowered when the tram is stationary.

It is desired to further improve the effectiveness of current collection devices for use when charging the batteries of a battery electric rail vehicle.

### SUMMARY OF INVENTION

In a first aspect of the present invention, there is provided a rail vehicle current collection shoe apparatus (for example for a rail vehicle comprising a battery) comprising: a current collection shoe for collecting current from a trackside charging contact; and an actuator configured to move the current collection shoe between a retracted position and a deployed position. The actuator is mechanically linked to the current collection shoe via a first support member and a second support member wherein the second support member is connected to the first support member by a frangible joint. The rail vehicle current collection shoe apparatus is configured to break at the frangible joint responsive to a shear force being applied to the current collection shoe and/or the first support member, the applied shear force exceeding a threshold shear force.

Advantageously, the provision of first and second support members with a frangible joint in this manner reduces or avoids damage to the rail vehicle, the current collection shoe apparatus and trackside objects in the event that the actuator should fail and the current collection shoe collide with a trackside object while the rail vehicle is in motion.

Preferably the first support member comprises a first electrically conducting portion (or is entirely electrically conductive); the second support member comprises a second electrically conducting portion (or is entirely electrically conductive); the first electrically conducting portion and the second electrically conducting portion are in contact in use so as to be electrically connected (for example at or proximate the frangible joint); and the current collection shoe is electrically connected to the first electrically conducting portion. This beneficially avoids the need for electrical connector components extended from one side of the frangible joint to the other.

Optionally the first support member comprises at least one first bore; the second support member comprises at least one second bore, the second bore positioned so as to align with the first bore; and the frangible joint comprises at least one elongate member, the elongate member positioned within the first and second bores and forming an interference fit with the first and second bores. For example, the elongate member may be a bolt having a thread and at least one of the first bore and the second bore is threaded to correspond with the thread.

Optionally, the elongate member, the first support member and the second support member are made from brass.

In a second aspect of the present invention, there is provided a rail vehicle current collection shoe apparatus (for example for a rail vehicle comprising a battery) comprising: a current collection shoe for collecting current from a trackside charging contact; and an actuator configured to move the current collection shoe between a retracted position and a deployed position. The actuator is connected to the current collection shoe via one or more resiliently deformable members; wherein the one or more resiliently deformable members are configured to deform (e.g., elastically), for example when under compression, when the current collection shoe in the deployed position is brought into contact with a trackside charging contact.

Advantageously, this arrangement allows the current collection shoe to be deflected as it is pushed against a trackside charging contact, thereby maximising contact area, reducing contact resistance, and improving current collection efficacy by the current collection shoe from the trackside charging contact.

Preferably the one or more resiliently deformable members are configured to deform under compression when the current collection shoe in the deployed position is brought into contact with a trackside charging contact such that the current collection shoe exhibits roll and/or pitch rotation relative to a rail vehicle direction of travel.

Optionally the one or more resiliently deformable members comprise four resiliently deformable members, each of the four resiliently deformable members positioned on an upper surface of the current collection shoe in use and proximate to a respective corner of the current collection shoe.

Preferably each of the one or more resiliently deformable members is made from an elastomeric material, optionally rubber.

In a third aspect of the present invention, there is provided a rail vehicle current collection shoe apparatus (for example for a rail vehicle comprising a battery) comprising: a current collection shoe for collecting current from a trackside charging contact; an actuator configured to move the current collection shoe between a retracted position and a deployed position; and a controller. The controller is configured to, in use: cause the actuator to move the current collection shoe to the deployed position, thereby pushing the current collection shoe against a trackside charging contact. While the current collection shoe remains in the deployed position, the controller is also configured to: monitor a force or pressure (or a proxy for the force or pressure, such as an air pressure of air supplied to a pneumatic actuator) between the current collection shoe and the trackside charging contact; and cause the actuator to maintain the force between the current collection shoe and the trackside charging contact above a threshold force.

Beneficially, this arrangement ensures good electrical contact between the current collection shoe and a trackside charging contact, dynamically responding to changes in height of the rail vehicle due to passengers embarking or disembarking, changes in wheel diameter due to wear, etc., and improving current collection efficiency during charging of the rail vehicle's battery.

Preferably the actuator is a pneumatic actuator; and monitoring the force between the current collection shoe and the trackside charging contact comprises monitoring an air pressure of the pneumatic actuator. Pneumatic actuators allow for rapid deployment and can also make use of existing compressed air provisions on the rail vehicle.

Preferably the actuator is connected to the current collection shoe via one or more return springs, advantageously ensuring the current collection shoe returns to/is maintained in a safe, retracted position in the event that an actuator, or a compressed air supply to an actuator, fails.

Preferably the rail vehicle current collection shoe apparatus further comprising one or more position sensors configured to monitor at least one of a position of the current collection shoe and an actuator stroke position. In such embodiments, when the controller instructs the actuator to move the current collection shoe from the retracted position to the deployed position or from the deployed position to the retracted position, the controller is configured to determine, based on signals received from the one or more position sensors, an amount of time taken for the actuator to move the current collection shoe from the retracted position to the deployed position or from the deployed position to the retracted position. Advantageously this monitored deployment time can be used as a means for detecting a potential fault or otherwise monitoring the condition of the actuators. For example, the one or more position sensors may comprise one or more limit switches that are engaged (e.g., actuated, switched) when an actuator stroke corresponds to the current collection shoe being in the retracted position, and when the actuator stroke corresponds to the current collection shoe being in the deployed position.

Alternatively, or in addition, the one or more position sensors comprise a sensor configured to measure an absolute actuator stroke position (that is, sensors capable of measuring a continuous position of the actuator stroke, such as an LVDT), wherein the controller is configured to monitor the absolute actuator stroke position each time the current collection shoe makes contact with a trackside charging contact. By monitoring the stroke position during deployment of the current collection shoe on a particular trackside charging contact over time (e.g., over the course of multiple visits to that trackside charging contact) a level of wear of the current collection shoe can be beneficially inferred.

In a fourth aspect of the present invention, there is provided a rail vehicle current collection shoe apparatus comprising: a current collection shoe for collecting current from a trackside charging contact; an actuator configured to move the current collection shoe between a retracted position and a deployed position; a first frame part affixed to and supporting the actuator; and a second frame part configured to be affixed to a rail vehicle underframe; wherein the first frame part is removably attached to the second frame part.

Advantageously this defines a modular design in which components including the first frame part, the actuator and current collection shoe can be easily swapped out from the rail vehicle as a single unit for maintenance repair or replacement, minimising the down time of the rail vehicle.

Preferably the first frame part comprises an extended portion; and the second frame part comprises a housing having an opening configured to receive the extended portion. This provides further mechanical support to the first frame part, as well as facilitating easier installation. It also allows the second frame part to be made specific to a particular type of rail vehicle, while ensuring compatibility with the first frame part, actuator and current collection shoe made as a unit to a standard design (i.e., by ensuring that at least the housing on the second frame part is to a standard design.

Optionally the apparatus also includes a third frame part, wherein: the second frame part is configured to be affixed to the rail vehicle underframe at a first position; the third frame part is affixed to the configured to be affixed to a rail vehicle underframe at a second position, the second position displaced from the first position with respect to a rail vehicle direction of travel; and the third frame part is removably attached to the first frame part. This advantageously provides additional support when the current collection shoe is in contact with, and moving across, a trackside charging contact.

In a fifth aspect of the present invention, there is provided a rail vehicle electrically conductive current collection shoe comprising: a contact surface, the contact surface facing a trackside conductor in use; a first end portion adjacent a middle portion, wherein the contact surface at the first end portion is at an angle relative to the contact surface at the middle portion, such that the thickness of the current collection shoe tapers towards a first end; a first side extending away from the contact surface at the middle portion; a first recess extending from a position in the first end portion, through at least a first part of the middle portion, to the first side.

Advantageously, as the current collection shoe slides across a trackside charging contact in use, the recess acts as a channel for moving snow, leaf litter, debris and/or corrosion away from a surface of the trackside charging contact.

Preferably, the current collection further comprises a second side extending away from the contact surface at the middle portion, the second side opposite the first side; wherein the first recess further extends from the position in the first end portion, through at least a second part of the middle portion, to the second side; and wherein the first recess is substantially symmetrical in a plane bisecting the contact surface parallel to a rail vehicle direction of travel (i.e., either forwards or reversed with respect to running rails). This arrangement advantageously ensures that no side load (i.e., force with a component orthogonal to direction of travel) is applied to the current collection shoe when sliding across a trackside charging contact. Optionally the first recess defines a chevron shape in the contact surface.

Preferably the current collection shoes further comprises: a second end portion adjacent the middle portion and opposite the first end portion, wherein the contact surface at the second end portion is at an angle relative to the contact surface at the middle portion, such that the thickness of the current collection shoe tapers towards a second end; and a second recess extending from a position in the second end portion, through at least a third part of the middle portion, to the first side. This beneficially provides for removal of snow/debris etc. regardless as to the direction of travel of the rail vehicle.

Preferably the second recess further extends from the position in the second end portion, through at least a fourth part of the middle portion, to the second side, again preferably being symmetrical plane bisecting the contact surface parallel to the rail vehicle direction of travel. Optionally the second recess defines a chevron shape in the contact surface. The second recess need not define the same shape as the first recess.

In a sixth aspect of the present invention, there is provided a rail vehicle current collection shoe apparatus comprising: a current collection shoe for collecting current from a trackside charging contact; an actuator configured to move the current collection shoe between a retracted position and a deployed position; and a return means configured to bias the current collection shoe to the retracted position; wherein the return means is configured to exert a substantially constant return force on the current collection shoe throughout a range of motion of the current collection shoe between the retracted and deployed positions.

Optionally, the return means comprises a pneumatic cylinder and a piston which divides an interior of the pneumatic cylinder into a first side and a second side, wherein the second side is fluidly connected to an air reservoir, further wherein the air reservoir has a volume which is larger than the volume of the pneumatic cylinder. Optionally, the actuator is a pneumatic actuator comprising an actuator cylinder having a piston which divides an interior of the actuator cylinder into a first actuator cylinder side and a second actuator cylinder side, wherein pressurisation of the first actuator cylinder side relative to the second actuator cylinder side causes deployment of the current collection shoe, wherein the second actuator cylinder side is fluidly connected to the air reservoir.

Alternatively or in addition, the return means comprises a constant force spring device comprising a strip of resilient material formed into a coiled configuration, further wherein a distal end of the strip of resilient material is fixed to the current collection shoe, such that the strip of resilient material unwinds as the current collection shoe is deployed.

Advantageously, such arrangements prevent the force required to deploy the shoe increasing as the extension of the shoe increases, reducing the overall force required to deploy the shoe and make good electrical contact with charging contacts, while at the same time providing means that can quickly and effectively retract the shoe in the event of failure of the actuator. In a seventh aspect of the present invention, there is provided a rail vehicle current collection shoe apparatus comprising the rail vehicle electrically conductive current collection described above.

In a eighth aspect of the present invention, there is provided a rail vehicle comprising any of the rail vehicle current collection shoe apparatuses above.

It will be appreciated that the above aspects are all compatible, and a rail vehicle or a rail vehicle current collection shoe apparatus can be provided having any combination of the features described above.

### BRIEF DESCRIPTION OF THE DRAWINGS

Embodiments of the present invention will now be described, by way of example only, with reference to the following figures. Like reference numerals refer to like elements throughout.

FIG. 1A shows a schematic side view of a portion of a battery electric rail vehicle in accordance with the present invention.

FIG. 1B shows a schematic top view of the battery electric rail vehicle of FIG. 1A.

FIG. 1C shows a schematic partial side view of the rail vehicle of FIGS. 1A and 1B, showing the rail vehicle current collection shoe apparatus in a retracted configuration.

FIG. 1D shows a schematic partial side view of the rail vehicle of FIGS. 1A to 1C, showing the rail vehicle current collection shoe apparatus in a deployed configuration.

FIG. 2 shows a perspective view of an example rail vehicle current collection shoe apparatus, from a viewpoint below a rail vehicle in accordance with the present invention mounted to a rail vehicle.

FIG. 3 shows a perspective view of a first portion of the rail vehicle current collection shoe apparatus of FIG. 2.

FIG. 4 shows a perspective view of a second portion of the rail vehicle current collection shoe apparatus of FIG. 2.

FIG. 5 shows a partial front view of the rail vehicle current collection shoe apparatus of FIG. 2.

FIG. 6 shows a partial cross-sectional view of the rail vehicle current collection shoe apparatus of FIG. 2.

FIG. 7A shows a perspective view of a current collection shoe in accordance with an aspect of the present invention.

FIG. 7B shows a plan view of the current collection shoe of FIG. 7A.

FIG. 8 shows a schematic view of a rail vehicle current collection shoe apparatus according to an alternative embodiment.

FIG. 9 shows a schematic view of a rail vehicle current collection shoe apparatus according to an alternative embodiment.

### DETAILED DESCRIPTION

Embodiments of the invention are described below in the context of battery electric multiple units. However, it will be readily appreciated that the invention is equally applicable to battery electric locomotives and other battery powered electric rail vehicles, including trams and light rail vehicles.

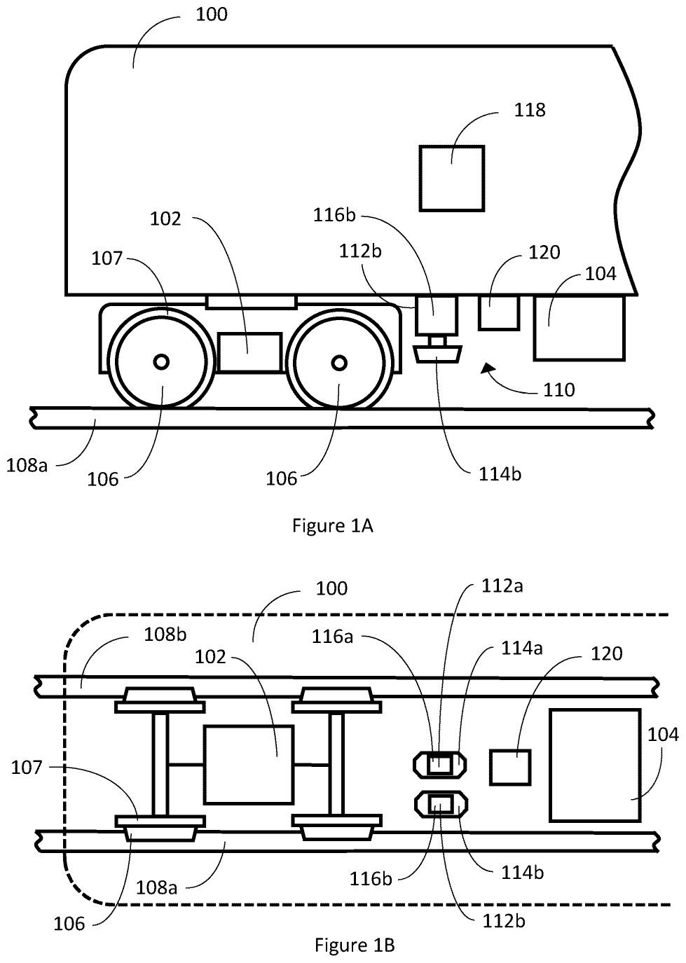

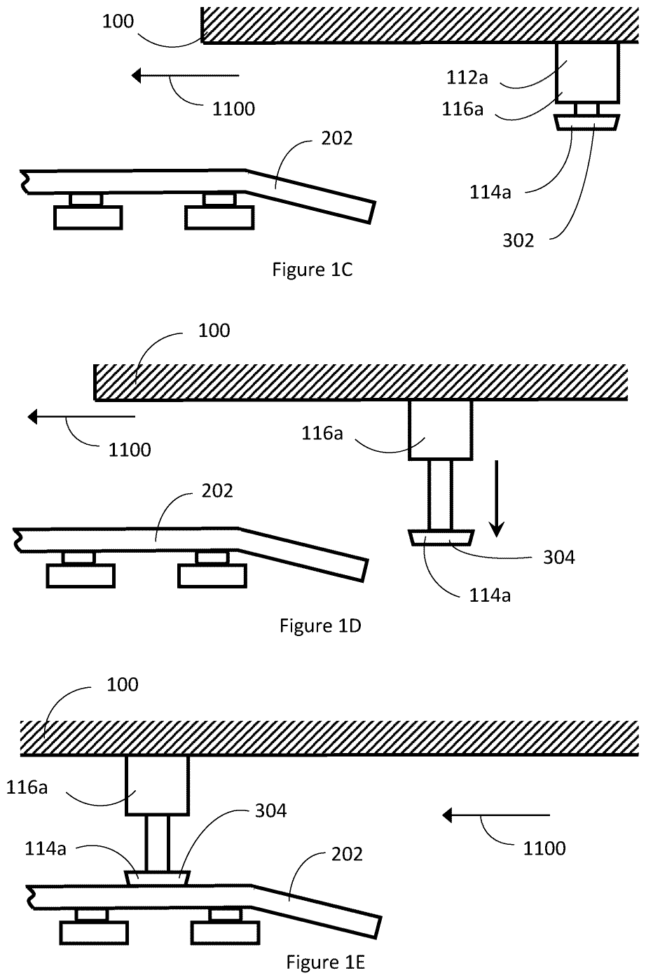

FIG. 1A shows a schematic side view of a portion of a battery electric rail vehicle 100. As shown, the battery electric rail vehicle 100 is a driving motor car in a battery electric multiple unit (BEMU), though it will be appreciated that the below applies equally to other types of battery electric rail vehicle. FIG. 1B shows a schematic top view of a portion of the same battery electric vehicle 100. In use, an electric motor 102 is configured to draw power from an on-board battery 104 and drive a plurality of driving wheels 106. The driving wheels 106 each have a flange 107 and run along first and second running rails 108a, 108b in the conventional manner.

The vehicle 100 also includes on-board (that is, vehicle-side) charging apparatus 110. The on-board charging apparatus 110 comprises at least one, and preferably at least two shoegear 112a, 112b positioned beneath the body of the driving motor car 100. Each shoegear 112a, 112b comprises an electrically conductive current collection shoe (also referred to as a charging shoe) 114a, 114b for use during charging, mounted to a respective actuator 116a, 116b. In the preferred embodiment, the charging shoes 114a, 114b are formed from a carbon-copper composite material, with a metallised carbon contact material, as is known in the art for use in conventional “third rail” electric rail vehicles (for example a carbon ceramic material with embedded copper threads such as MY258P grade Morganite® produced by Morgan Advanced Materials). The current collection shoes 112a, 112b can either comprise a single piece of electrically conductive material, or be an assembly of multiple components. We note that such materials are particularly advantageous over more traditional cast iron shoes used for some third rail electric vehicles in the present context—materials such as cast-iron risk being welded to the charging rail due to the high currents involved during charging and the fact the vehicle is stationary during charging in the present invention. In one example, the charging shoes 114a, 114b are rated to carry currents up to 1000 A at 850V. Preferably the actuators 116a, 116b are pneumatic actuators, although hydraulic or electromechanical actuators can alternatively be used. The use of pneumatic actuators is particularly beneficial, in that it allows for flexibility in ride height due to wheel wear or vehicle load (which might change while charging is in progress) while maintaining a constant force on the charging shoe 114a, 114b—this is discussed in more detail below. Pneumatic actuators allow for rapid deployment of the charging shoe 114a, 114b. As a further advantage, pneumatic actuators can also make use of pre-existing compressed air supplies on the electric rail vehicle 100, providing for a reduced component count and simpler installation/retrofitting.

It will be appreciated that multiple charging apparatuses 110 may be provided. Preferably, driving motor car 100 is part of a train consist, for example part of a multiple unit comprising a second driving motor unit (not shown) and optionally one or more non-driving carriages (not shown) between the driving motor car 100 and the second driving motor car. In such cases, one or more further charging apparatuses 110 can be provided on the second driving motor car and/or non-driving carriages. Alternatively, or in addition, driving motor car 100 may be provided with two or more charging apparatuses 110.

A controller 118 is also provided to control actuation of the actuators 116a, 116b. Each actuator 116a, 116b, under control of the controller 118, is configured to move its associated charging shoe 114a, 114b between different positions, as explained in greater detail below. While the present embodiment as illustrated in FIGS. 1A and 1B employs a different actuator 116a, 116b for each charging shoe 114a, 114b, in alternative embodiments a single actuator may be used to simultaneously change the position of all of the charging shoes 114a, 114b provided in the on-board charging apparatus 110. In some examples, the controller 118 is or includes a traction control unit.

Preferably, the charging apparatus also includes a receiver 120 configured to receive wireless communication signals, for example a transceiver for interrogating RFID beacons.

The shoegear 112a, 112b can be positioned at various points on the underside of the driving motor car 100. A preferred position is proximate to, but forward of a trailing bogie of the driving motor car 100—this position helps ensure that the trackside charging contacts (discussed below) are fully covered by the driving motor car 100 itself during charging.

Operation of the shoe gear 112a, 112b is shown generally in FIGS. 1C and 1D. Certain elements of the rail vehicle 100 have been omitted from FIGS. 1C and 1D in the interest of clarity of explanation. FIG. 1C shows driving motor car 100 in motion, travelling towards a trackside charging contact 202 in the rail vehicle direction of travel 1100 (right to left as shown). The trackside charging contact 202 is connected to a source of electrical power (not shown) and is configured to provide a charging current to the battery 104 via the current collection shoes 114a, 114b. As shown in FIG. 1C, the charging shoe 114a is in a retracted position 302. As detailed further below, in the retracted position 302 the charging shoe 114a is held within the applicable vehicle gauge requirements for the route being taken by the driving motor car 100 (for example, above the gauge line as defined in RSSB standard GE/RT8073). In some examples, when in the retracted position 302, the lowest part of the charging shoe 114a is held at position higher than the lowest part of the motor 102.

Responsive to detecting that the driving motor car 100 is approaching the trackside charging contact 202, the controller 118 instructs the actuator 116a to move the charging shoe 114a from the retracted position 302 to a deployed or extended position 304, as shown in FIG. 1D. The rail vehicle 100 continues to move in the rail vehicle direction of travel 1100 as the charging shoe 114a is brought into contact with (e.g., pushed against) the trackside charging contact 202, sliding the charging shoe 114a across at least a portion of the surface of the trackside charging contact 202, as shown in FIG. 1E. Once the driving motor car 100 is stationary with the charging shoe 114a in electrical contact with the trackside charging contact 202, charging of the battery 104 commences.

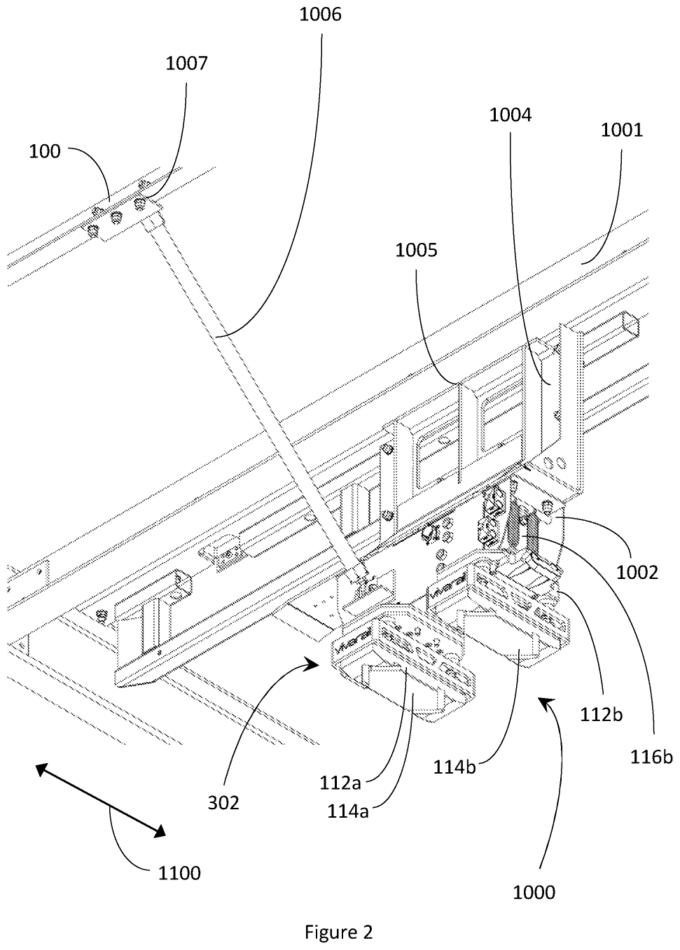

Further details of the shoegear 112a, 112b are described with reference to the embodiments of a current collection shoe apparatus 1000 as illustrated in FIGS. 2 to 9. Throughout these figures, arrows 1100 indicate a direction of travel of the rail vehicle 100. References to the rail vehicle direction of travel 1100 refer to the possible directions in which the rail vehicle 100 can travel (i.e., forwards or backwards as constrained by the running rails 108a, 108b), and do not necessarily require that the rail vehicle 100 is actually moving. It is also noted that a “forwards” direction for a first driving motor car 100 at one end of a train may correspond to a “backwards” direction for a second driving motor car at an opposite end of the train and vice versa.

FIG. 2 shows a perspective view of a rail vehicle current collection shoe apparatus 1000 to the underframe 1001 of the rail vehicle 100. As shown, the current collection shoe apparatus 1000 comprises both first and second shoegear 112a, 112b. It will be appreciated that separate current collection shoe apparatuses could be provided for each shoegear 112a, 112b, however, providing at least two shoegear 112a, 112b in a single apparatus 1000 provides all the contacts needed to enable charging of the battery 104 as a single unit.

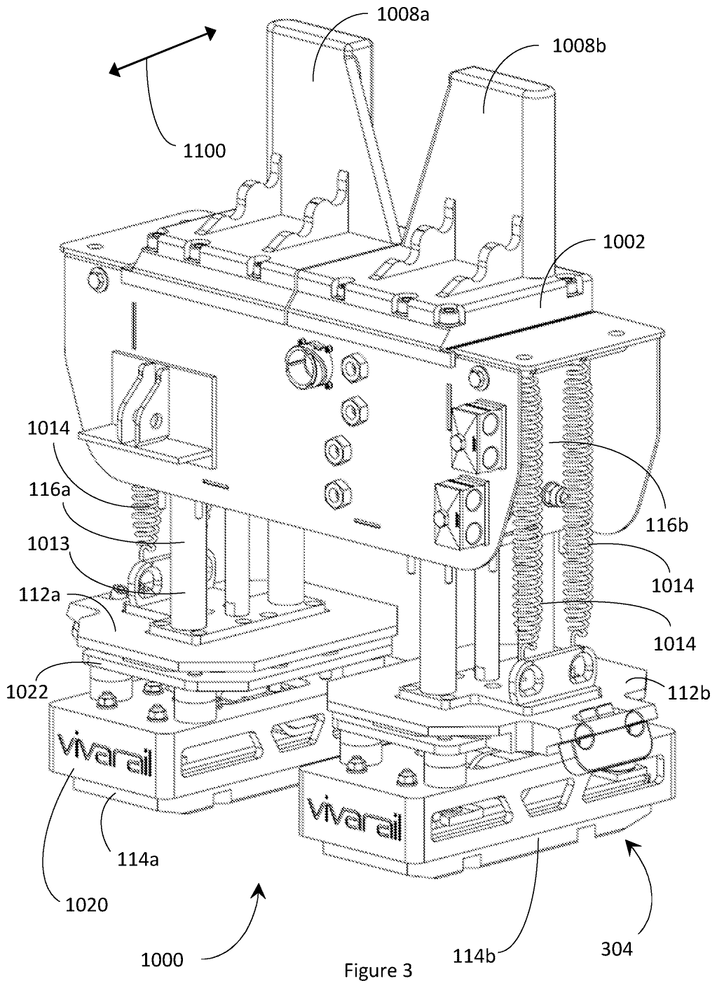

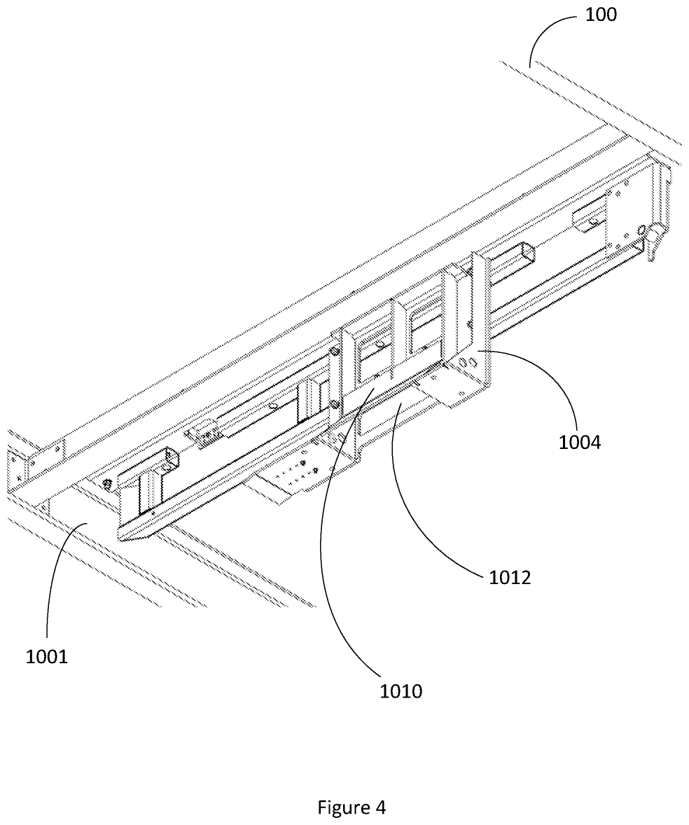

The apparatus 1000 includes a first frame part 1002 supporting the actuators 116a, 116b, the actuators linked to the current collection shoes 114a, 114b (in this case via intermediate components as described below). In use, the first frame part 1002 is removably fixed to a second frame part 1004, which is in turn fixed to a first position 1005 on the underframe 1001 of the rail vehicle 100. FIG. 3 shows elements of the apparatus 1000 when the first frame part 1002 has been removed from the second frame part. Similarly, FIG. 4 shows the second frame part 1004 in situ on the underframe 1001 when the first frame part 1002 has been removed. Advantageously, provision of the two removably attached frame parts 1002, 1004 provides a modular arrangement wherein the first frame part 1002 (and the connected actuators 116a, 116b and current collection shoes 114a, 114b) can be easily removed, minimises the amount of time the rail vehicle 100 is not available for normal operation due to inspection, maintenance, or repair. For example, if a current collection shoe 114a, 114b or actuator 116a, 116b required maintenance, the first frame part 1002 can be removed from the second frame part 1004, and a replacement first frame part 1002 (including corresponding current collection shoes 114a, 114b and actuators 116a, 116b) can be immediately fitted. The rail vehicle 100 is then able to continue operating with minimal delay while maintenance is performed on the removed components. Additionally, by mounting the apparatus 1000 to the underframe 1001 of the body of the rail vehicle 100, rather than to the bogies, the apparatus 1000 i) is subjected to less vibration during motion of the rail vehicle, increasing the longevity of the apparatus 1000, and ii) can be easily fitted or retrofitted to a variety of different vehicles (bogie design across different rail vehicles may differ considerably, whereas underframe design is typically more similar).

A third frame part 1006 is also provided, the third frame part 1006 fixed to a second position 1007 on the underframe 1001, and removably attached to the first frame part 1002. The second position 1007 on the underframe 1001 is displaced from the first position 1005 relative to the rail vehicle direction of travel 1100. By mechanically linking the first frame part 1002 to the underframe at two different positions 1005, 1007 in this manner, the first frame part 1002 is provided additional support against bending moments when subject to forces parallel to the direction of travel 1100 (such forces occur when a current collection shoe 114a, 114b is pushed against a trackside charging contact while the rail vehicle 100 is in motion, as discussed above). Further, this arrangement beneficially acts to damp low frequency vibration by the current collection shoe apparatus 1000.

As shown, the first frame part 1002 comprises one or more extended portions (e.g., plugs) 1008a, 1008b (in the present embodiment two extended portions 1008a, 1008b are provided). Principally the extended portions 1008a, 1008b are themselves housings for limit switches and other components relation to control and monitoring of the actuators 116a, 116b (as discussed in more detail below). However, the second frame part 1004 has a corresponding housing (e.g., socket) 1010 configured to receive the extended portions 1008a, 1008b of the first frame part 1002 via an opening 1012, advantageously allowing for fast locating and installation of the first frame part 1002 in the second frame part 1004. As shown, in use the extended portions 1008a, 1008b and housing 1010 extend in a generally vertical direction, though it will be appreciated that they may alternatively extend in a different direction. The extended portions 1008a, 1008b form a tight fit, (e.g., and interference fit) with the housing 1010. During installation, the extended portions 1008a, 1008b slide into the housing in a first direction (in the case of the arrangement shown in FIGS. 2 to 4, a substantially vertical direction), and held in place by means of one or more removable fastener, for example one or more bolts extending through both the housing 1010 and extended portions 1008a, 1008b in a second direction (in the illustrated example, substantially horizontally) at an angle to (e.g., orthogonal to) the first direction.

Advantageously, the configuration of the second frame part 1004 can be tailored to the specific vehicle on which the apparatus 1000 is to be installed, while retaining a standard shape to the housing 1010. This allows the first frame part 1002 (and the actuators 116a, 116b, current collection shoes 114a, 114b and other connected components) to be made to a standard design for use across many different types of rail vehicle, simplifying manufacture, maintenance, and servicing.

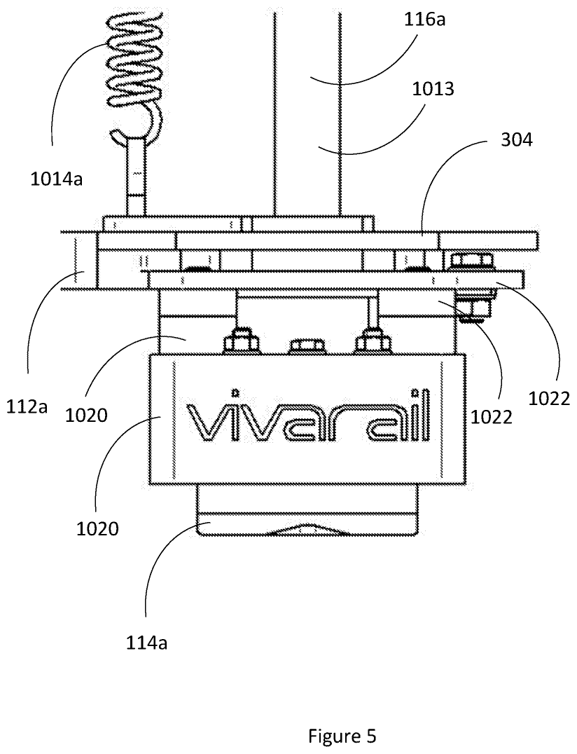

In the embodiment of FIGS. 2 to 7B, the actuators 116a, 116b of the current collection shoe apparatus 1000 are pneumatic actuators. As described above, controller 118 is configured to cause the actuators 116a, 116b to move the respective current collection shoes 114a, 114b between retracted and deployed positions. The current collection shoes 114a, 114b are shown in a retracted position 302 in FIG. 2, and in a deployed position 304 in FIGS. 3 and 5. In the retracted position 302, actuator shafts 1013 of the actuators 116a, 116b are retracted (for example at or near a fully retracted end-of-stroke position), and the current collection shoes 114a, 114b are held within the applicable vehicle gauge requirements for the route being taken by the driving motor car 100 (for example, above the gauge line as defined in RSSB standard GE/RT8073). In the deployed position 304, the actuator shafts 1013 are extended (for example at or near a fully extended end-of stroke position), and the current collection shoes 114a, 114b are held at a lower position (which may be below vehicle gauge requirements for normal running) such that they are in contact with trackside charging contacts 202 or can be brought into contact with trackside charging contacts 202 as the rail vehicle 100 travels over the trackside charging contacts 202 as described above.

Advantageously, in this embodiment the actuators 116a, 116b are connected to the respective current collection shoes 114a, 114b via one or more return means configured to bias the current collection shoes 114a, 114b towards their respective actuator 116a, 116b. In this embodiment, return springs 1014 (for example coil springs as illustrated) are provided for this purpose. In the event that the supply of compressed air to the actuators 116a, 116b should fail for any reason, the return springs 1014 act to cause to the current collection shoes 114a, 114b to stay in, or return to, the retracted position 302 (or at least to a position such that the current collection shoe 112a, 112b is within an applicable gauge), enhancing safety as the rail vehicle 100 continues to move.

Once the current collection shoes 114a, 114b have been brought into contact with respective trackside charging contacts 202, the controller 118 is configured to monitor the actuator air pressure, which is indicative of the force exerted by the actuators 116a 116b on the actuator shafts 1013, and hence the force exerted by the current collection shoes 114a, 114b on the respective trackside charging contacts 202. The monitored air pressure is compared to a threshold air pressure. For example, the threshold air pressure may correspond to a threshold force between the current collection shoes 114a, 114b and respective trackside charging contacts 202 of 250N. If the monitored air pressure falls below the threshold, the controller 118 is configured to increase the air pressure supplied to the actuators 116a, 116b. For example, a pressure switch connected to an air supply for the actuator 116a, 116b may be set to trigger (e.g., actuate, engage) at an actuator 116a, 116b air supply pressure that corresponds to the threshold force, for example giving an indication to the controller 118 that the threshold force has been met/exceeded. By doing so, the charging apparatus 110 automatically and dynamically maintains good electrical contact between the current collection shoes 114a, 114b and the respective trackside charging contacts 202. For example, the present embodiment ensures that good electrical contact (and hence high charging currents/low contact resistance) is maintained as passengers disembark from the rail vehicle 100, which typically causes the vehicle 100 to rise on its suspension, moving the underframe 1001 higher and away from the trackside charging contacts 202. In one example, the controller 118 is configured to apply an appropriate air pressure such that the force between the current collection shoes 114a, 114b and respective charge contacts 202 remains in the range 250-500N.

It is noted that monitoring the compressed air supply pressure to the actuator 116a, 116b as a proxy for monitoring the force between the current collection shoe 114a, 114b and the trackside charging contact 202 is particularly beneficial, as it automatically accounts for changes in downwards actuation force needed to overcome changes to the opposing return spring 1014 force as the height of the vehicle 100 changes (as passengers disembark, the height of the vehicle 100 increases, the actuator 116a, 116b has to extend further, the return springs 1014 also extend further and exert a greater force opposing extension of the actuator 116a, 116b). As an alternative, the controller 118 may monitor the force or pressure between the current collection shoes 114a, 114b and the trackside charging contact 202, or a proxy thereof, in any other appropriate manner.

Preferably the rail vehicle current collection shoe apparatus 1000 further comprising one or more position sensors (not shown) configured to monitor either the position of the current collection shoes 114a, 114b, an actuator stroke position (e.g., an extension amount/length of the actuator rods 1013), or both. In the preferred embodiment, limit switches are provided to indicate when each actuator 116a, 116b has reached either end of its stroke. In the arrangement shown in FIGS. 2 to 7B, limit switches are housed within extended portions 1008a, 1008b. For each actuator 116a, 116b, the limit switches are respectively triggered (e.g., switched/actuated/engaged) when the corresponding current collection shoe 114a, 114b is in the retracted position or when the corresponding current collection shoe 114a, 114b is in the deployed position. In this embodiment, after causing an actuator 116a, 116b to move the corresponding current collection shoe 114a, 114b, the controller 118 is configured to determine, based on signals received from the one or more position sensors (e.g., the limit switches), an amount of time taken for the actuator 116a, 116b to move the current collection shoe 114a, 114b from the retracted position 302 to the deployed position 304 or from the deployed position 304 to the retracted position 302. In this way the controller 118 can monitor a condition of the actuators 116a, 116b or a compressed air supply to the actuator. For example, an increase in the time taken to deploy or retract the current collection shoes 114a, 114b may indicate a compressed air leak, or additional friction inhibiting the actuator rods 1013. Such information can be used to determine whether the apparatus 1000 requires inspection or maintenance.

Alternatively, or in addition, the one or more position sensors may comprise a sensor configured to measure an absolute actuator stroke position (that is, measure a continuous position of the actuator stroke/extension length of the actuator rods 1013). In this arrangement, the controller 118 is configured to monitor the absolute actuator stroke position each time the current collection shoe makes contact with a trackside charging contact 202 (for example a particular trackside contact 202). Each time a current collection shoe 114a, 114b makes contact with and slides along a trackside contact 202, it will be subject to wear, and as a result the thickness of the current collection shoe 114a, 114b will decrease over time. Accordingly, the actuator stroke position will gradually increase each time the current collection shoe makes contact with a trackside charging contact 202. By measuring this over time, the thickness of the current collection shoes 114a, 114b can be monitored, and used to determine whether the current collection shoes 114a, 114b require inspection or replacement.

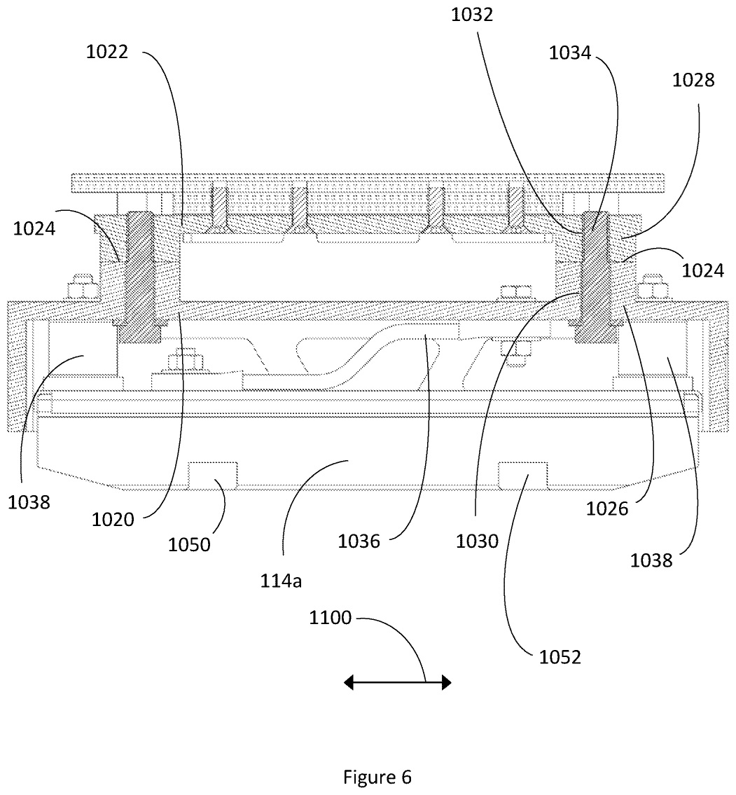

As shown best in FIG. 6, each current collection shoe 114a, 114b is mechanically linked to its respective actuator 116a, 116b via one or more resiliently deformable members or buffers 1038, for example elastomeric components, such as rubber cylinders. In the illustrated embodiment, the resiliently deformable members 1038 are retained between the current collection shoes 114a, 114b and respective first support members 1020 (which are described in further detail below) by respective bolt, though other suitable attachment means could be used.

The resiliently deformable members 1038 are configured to deform under compression when the current collection shoe 114a, 114b in the deployed position 304 is brought into contact with/pushed against the trackside charging contact 202 by the actuators 116a, 116b. Advantageously, the resiliently deformable members 1038 ensure that the current collection shoe 114a, 114b lies substantially flush against the surface of the trackside charging contact 202, hence maximising the contact area and reducing the contact resistance between the current collection shoe 114a, 114b and the trackside charging contact 202. For example, if the surface of the charging contact 202 lies at a different angle with respect to that of the current collection shoe 114a, 114b, the resiliently deformable members 1038 deform under the force exerted against the trackside charging contact 202 by the actuator 116a, 116b, thereby allowing the current collection shoe 114a, 114b to rotate about a roll axis parallel to the rail vehicle direction of travel 1100, and/or rotate about a pitch axis orthogonal to the rail vehicle direction of travel 1100 (i.e. orthogonal to the plane of the cross section of FIG. 6). Accordingly, the current collection shoe 114a, 114b is compliant, and a surface of the current collection shoe is able to conform to the angle of the surface of the trackside charging contact 202 to improve current collection.

As best illustrated in FIG. 6, the shoegear 112a, 112b include a respective first support 1020 and a second support member 1022. Each actuator 116a, 116b is fixed to a respective second support member 1022 (either directly or via intermediate components as shown in FIGS. 5 and 6). Each current collection shoe 114a, 114b is fixed to respective first support member 1020 (preferably via resiliently deformable members 1038 as described above). In an alternative arrangement, each current collection shoe 114a, 114b is fixed to a respective first support member 1020 (directly or via intermediate components), and the second support 1022 member is fixed to a respective actuator 116a, 116b via resiliently deformable members 1038.

Each second support member 1022 is connected to a respective first support member 1020 by a frangible joint 1024. Thus, each actuator 116a, 116b is mechanically linked to respective current collection shoes 114a, 114b via the first support member 1020 and the second support member 1022.

The rail vehicle current collection shoe apparatus 1000 is configured to break at the frangible joint 1024 responsive to a shear force being applied to the current collection shoe 114a, 114b, and/or the first support member if the applied shear force exceeds a threshold shear force. Advantageously, this provides enhanced protection both for the rail vehicle and for trackside objections such as AWS apparatus, switch rails, etc. In the event that an actuator 116a, 116b were to fail such that a current collection shoe 114a, 114b was no longer held in the retracted position 302 during normal running of the rail vehicle 100 (i.e. when the rail vehicle 100 is not proximate to the trackside charging contact 202), and in the event that a current collection shoe 114a, 114b were to strike a trackside object due to continued movement of the rail vehicle 100, the apparatus 1000 would break at the frangible joint 1024, reducing or avoiding damage to both the trackside object, the apparatus 1000 (exempting the frangible joint 1024), and the underframe 1001 and other components of the rail vehicle 100. It is noted that this is particularly beneficial in the context of retractable/deployable current collections shoes 114a, 114b, where the position of the current collection shoes 114a, 114b relative to trackside infrastructure and objects is inherently subject to change. In the preferred embodiment, the relative dimensions of the first support member 1020 and the second support member 1022 are such that, in the event that the frangible joint 1024 breaks, the second support member 1022 remains within the applicable gauge, for all possible extensions of the actuators 116a, 116b.

In the present embodiment, the frangible joint 1024 takes the form of one or more bores 1030 in the first support member 1020, one or more correspondingly positioned bores 1032 in the second support members 1022, wherein the first support member 1020 and the second support member 1022 are held together, preferably in close contact, by means of elongate members 1034 extending between respective bores 1030, 1032. Optionally each elongate member forms a close fit, or an interference fit with respective first and second bores 1030, 1032. In the preferred embodiment the elongate member 1034 is a bolt having a thread and at least one of the first bore 1030 and the second bore 1032 (and more preferably, both) is threaded to correspond with the thread of the bolt.

It will be appreciated that the thickness, geometry, and material of the elongate member 1034 will determine the shear force that has to be applied to the first support member 1020 (and/or current collection shoe 114a, 114b) in order to break all the elongate members 1034 provided per shoegear 112a, 112b, and may be chosen accordingly. In one example, the elongate members 1034 are four M12 brass bolts, which have been found to break at impact energies of 500 J or higher.

Preferably the first support member 1020 and the second support member 1024 have respective electrically conductive portions 1026, 1018 in contact with each other, for example at one or more of the frangible joints 1034. In this arrangement, the current collection shoe 114a, 114b is electrically connected to the electrically conductive portion 1026 of the first support member 1020 (e.g., via a braided wire or other electrical connector 1036). Accordingly, a path for charging current away from the current collection shoes 114a, 114b is provided without requiring a fixed electrical conductor component between the two sides of the frangible joint. In the illustrated embodiment, the entirety of the first and second support members 1020, 1022 are made from an electrically conductive material such as brass.

In an alternative arrangement, a single resiliently deformable member 1038 can be provided made from suitably shaped brass or another electrically conductive resiliently (e.g., elastically) deformable material. In this arrangement, the resiliently deformable member 1038 can also fulfil the roles of the conductive portion 1026 and the electrical connection 1036.

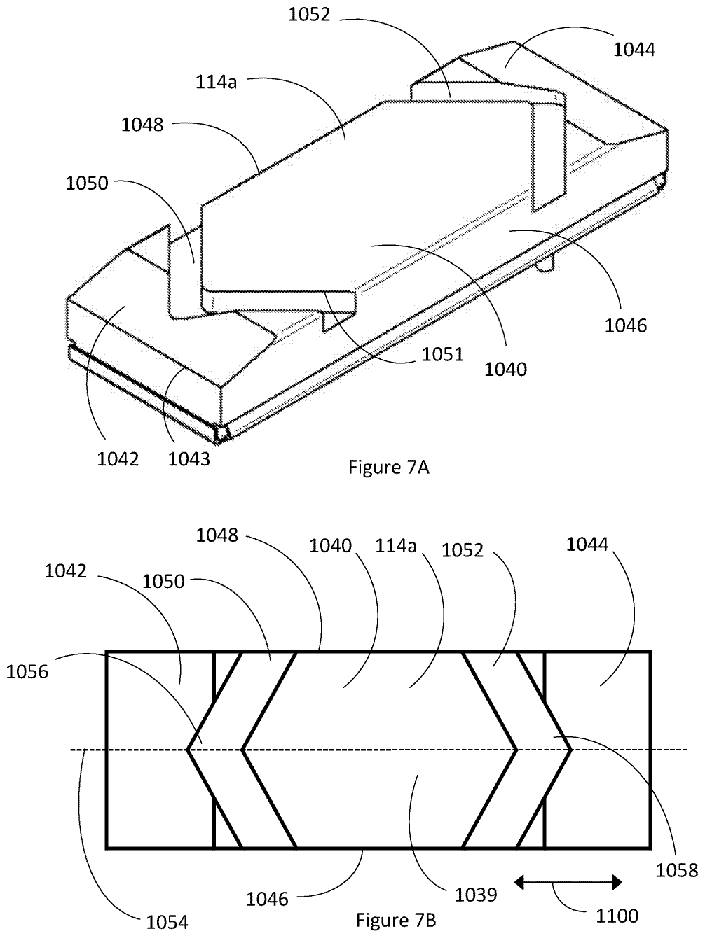

Each current collection shoe 114a, 114b comprises one or more recesses or channels 1050, 1052 as best shown in FIGS. 7A and 7B. Each current collection shoe 114a, 114b includes a contact surface 1039, that is, the surface that is pushed against a trackside contact 202 in use. Preferably, each current collection shoe 114a, 114b has one or more middle portions 1040, and first and second end portions 1042, 1044 adjacent the middle portion(s) 1040, wherein the contact surface 1039 at the first and second end portions 1042, 1044 is at an angle relative to the contact surface 1039 at the middle portion, such that the thickness of the current collection shoe 114a, 114b tapers towards its forward and trailing ends (it will be appreciated that which end is forward or trailing depends on which direction the rail vehicle 100 is travelling in). Put differently, the first and second end portions 1042, 1044 define ramp portions diverging away from (in this embodiment, upwards) the contact surface 1039 at the middle portion 1040. In less preferred embodiments, only a single end portion, e.g., first end portion 1042, is provided in combination with the middle portion 1040.

Each current collection shoe 114a, 114b has a first side 1046 and a second side 1048. In FIGS. 7A and 7B, the first sides are shown as being substantially parallel to the rail vehicle direction of travel 1100 and substantially orthogonal to the contact surface 1039, however it will be appreciated that the sides 1046, 1048 can have any suitable geometry.

Each current collection shoe 114a, 114b includes a first recess or channel/slot 1050 in the current collection surface 1039 extending from a position 1056 in the first end portion 1042, through at least a first part of the middle portion 1040, to the first side 1046. Beneficially, this recess 1052 provides a route facilitating the removal of contaminants such as snow, leaf litter, corrosion and/or other debris from the trackside charging contact 202 when the current collection shoe 114a, 114b slides across it (when the first end portion 1042 is the leading end of the current collection shoe 114a, 114b). In particular, contaminants lying on top of the trackside charging contact 202 can be collected in the first recess 1050, passing through a gap between the contact surface 1039 and the trackside charging contact corresponding to the portion of the recess 1050 extending into the first end portion 1042, and channeled off/away from the surface of the trackside charging contact 202 through motion of the rail vehicle 100.

The combination of a recess 1050 as described above with the tapered first end portion 1042 is also particularly advantageous. The tapering of the first end portion 1042 allows a leading edge 1043 of the contact surface 1039 to be substantially orthogonal to the rail vehicle direction of travel 1100, beneficially avoiding a twisting force being applied to the current collection shoe 114a when it contacts and slides across the trackside charging contact 202, whilst simultaneously providing an angled edge 1051 (in the recess 1050) to direct debris away from the charging rail.

In the preferred embodiment, the first recess 1050 is symmetrical in a plane 1054 bisecting the contact surface 1039 parallel to a rail vehicle direction of travel 1100 (that is, the plane 1054 has a normal that is orthogonal to the rail vehicle direction of travel 1100, the normal lying in the place of the contact surface 1039 at the middle portion 1040). In particular, the first recess 1050 also extends from the position 1056 in the first end portion, through at least a second part of the middle portion 1040, to the second side 1048. Beneficially, this symmetrical arrangement ensures that the frictional load on the current collection shoe 114a, 114b when sliding across the trackside charging contact 202 is symmetrical. Accordingly, this arrangement avoids a side load (i.e., a force having a component in a direction orthogonal to the rail vehicle direction of travel 1100) being placed on the current collection shoe 114a, 114b when sliding across the trackside charging contact 202. In the illustrated example, the first recess 1050 defines a chevron shape.

Preferably, each current collection shoe 114a, 114b also includes a second recess 1052 in the current collection surface 1039 extending from a position 1058 in the second end portion 1044, through at least a third part of the middle portion 1040, to the first side 1046. Advantageously, the provision of a second recess 1052 in this manner allows for clearing of contaminants from the trackside charging contact 202 when the direction of travel of the rail vehicle 100 is reverse, i.e., when the second end portion 1044 is the leading end of the current collection shoe 114a, 114b. Again, the second recess 1052 is preferably symmetrical in the plane 1054, and the second recess 1052 extends from the position 1058 in the second end portion 1044, through at least a fourth part of the middle portion 1040, to the second side 1048, for example a chevron shape.

As shown, the second recess 1052 is a mirror image of the first recess 1050, though it will be appreciated that the first and second recesses 1050, 1052 can alternatively have different geometries.

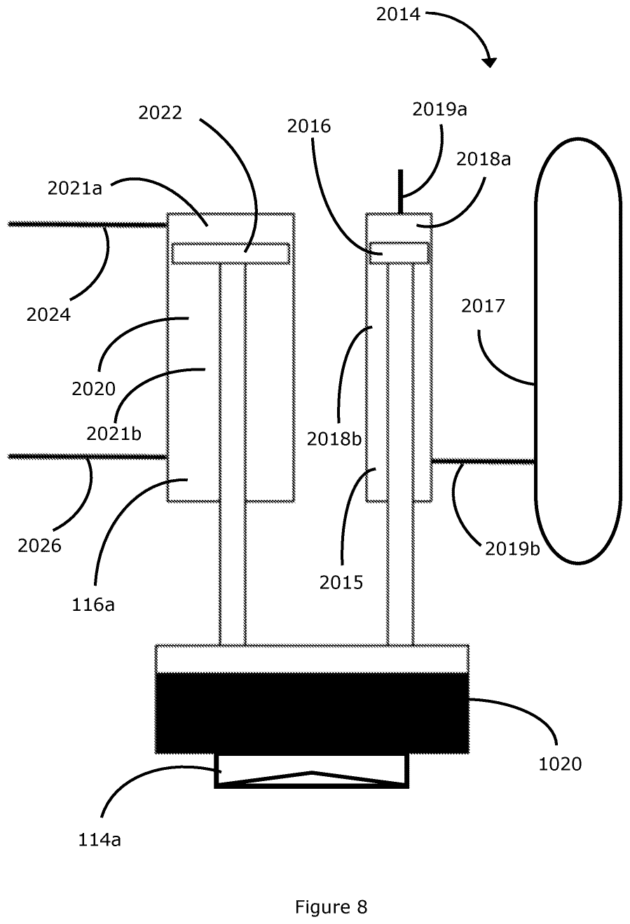

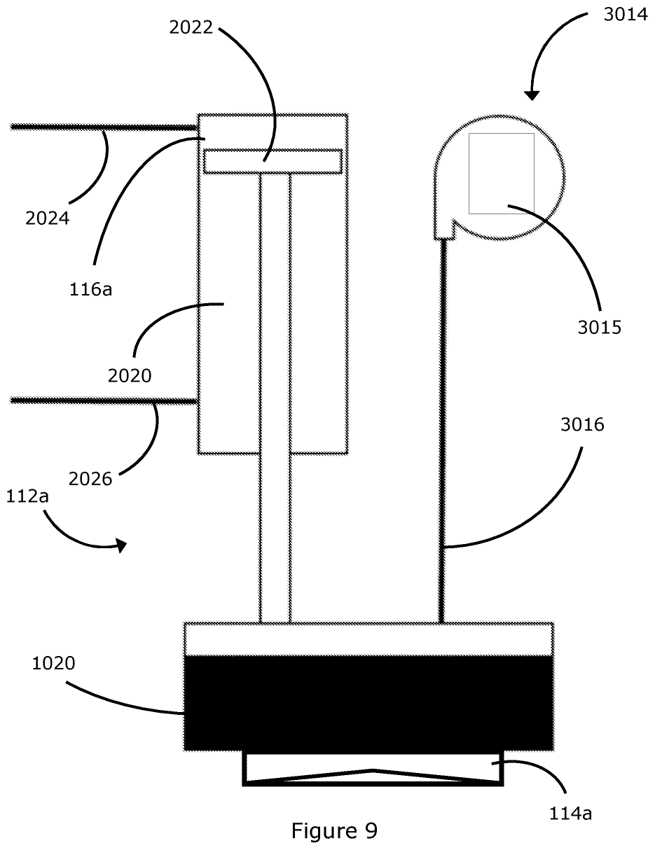

FIGS. 8 and 9 depict variant return means configured to bias the current collection shoes 114a, 114b towards their respective actuator 116a, 116b. The arrangements of FIGS. 8 and 9 employ return means (in particular constant force springs) 2014, 3014 in place of the helical wire springs 1014 employed in the embodiment of FIGS. 2 to 7B.

In FIGS. 8 and 9, the actuator 116a is shown schematically as a pneumatic actuator comprising a piston 2022 located within a pneumatic cylinder 2020. The piston 2022 divides the pneumatic cylinder 2020 into a first side 2021a and a second side 2021b. The pneumatic cylinder 2020 has a first connection 2024 to a compressed air supply to the first side 2021a and a second connection 2026 to the compressed air supply to the second side. As shown, compressed air supplied to the pneumatic cylinder 2020 via the first connection 2024 acts to deploy the current collection shoe 114a, whereas compressed air supplied to the pneumatic cylinder 2020 via the second connection 2026 acts to retract the current collection shoe 114a. Put differently, pressurisation of the first side 2021a relative to the second side 2021b deploys the current collection shoe.

In FIG. 8, the return means comprise an air spring 2014 comprising a pneumatic cylinder 2015 having a piston 2016, and an air reservoir 2017. The piston 2016 divides an interior of the pneumatic cylinder 2015 into a first side 2018a and a second (“return”) side 2018b, wherein the second side 2018b is fluidly connected to the air reservoir 2017 via a port 2019b. The air reservoir 2017 is preferably a sealed volume of air, for example a dedicated tank, or alternatively part of, or comprises, an extended system of elements defining a sealed volume. The air within the reservoir is held at a pressure above atmospheric pressure, for example between 50 psi (345 kPa) and 60 psi (415 kPa). The first side 2018a of the pneumatic cylinder 2015 is connected to atmosphere via connection/vent 2019a.

In an alternative arrangement, the reservoir is, or comprises, a compressed air supply configured to supply air of a substantially constant pressure to the second side 2018b of the pneumatic cylinder 2015.

The air reservoir 2017 preferably has a volume greater than the maximum volume of the pneumatic cylinder 2015, such that the effect of the movement of the piston 2016 has little effect on the overall system pressure. For example, the volume of the reservoir 2017 is optionally around 10 times the volume of the pneumatic cylinder 2015, in which case the pressure in the reservoir 2017 across the full stroke range of the piston 2016 may vary by roughly 10%. In some embodiments the volume of the reservoir 2017 is greater than 10 times the volume of the pneumatic cylinder 2015.

This arrangement beneficially results in a retraction force exerted on the current collection shoes 114a by the air spring 2014 that remains substantially constant throughout the operation of the system.

Each pneumatic cylinder 2015 may be connected to its own respective air reservoir 2017. Alternatively, the return means may comprise a number of pneumatic cylinders 2015 each connected to a shared air reservoir 2017. It will be appreciated that in the latter case, the capacity of the air reservoir is preferably greater than the summed total of all of the maximum capacities of the pneumatic cylinders 2015 connected to the reservoir 2017.

In the illustrated embodiment, the second connection 2026 of the actuator cylinders 2020 is connected to a compressed air supply which is independent of the air spring arrangement. Such arrangements allow for independent control and operation of each actuator 116a, 116b. However, according to an alternative arrangement, the second connection 2026 of the actuator cylinder 2020 can be connected to the reservoir 2017 of the air spring 2014. This allows for the automatic retraction of the current collection shoe 114a upon the release of deployment air pressure from the first connection 2024.

In a further alternative arrangement, the reservoir 2017 is connected to the first side 2018a of the pneumatic cylinder 2015 via connection 2019a, and the second side 2018b of the pneumatic cylinder 2015 is connected to atmosphere via connection 2019b. In this arrangement, the reservoir 2017 contains air at a pressure less than atmospheric pressure, for example a vacuum or partial vacuum. Again, this arrangement beneficially results in a retraction force exerted on the current collection shoes 114a by the air spring 2014 that remains substantially constant throughout the operation of the system.

FIG. 9 shows an alternative arrangement in which the return means comprise a constant force spring device 3014. The constant force spring device 3014 provides a near-constant return force throughout its range of motion.

Each constant force spring device 3014 comprises a wound strip 3016 of a resilient material formed into a coiled configuration 3015 as known in the art. A distal end of the strip 3016 is fixed to a respective one of the current collection shoes 114a, 114b and a proximate end of the strip 3016 is fixed to and rotatable about an axis, the axis fixed with respect to the rail vehicle 100, such that deployment of the shoe 114a, 114b causes the strip 3016 to unwind. When the strip is unwound, the inherent tension in the strip provides a substantially constant force acting in a retraction direction of the current collection shoes 114a, 114b, regardless of the extent of its unwinding. This constant force output is substantially independent of the displacement of the current collection shoe 114a.

The use of constant force springs, as in the arrangements of FIGS. 8 and 9, advantageously means that the force that must be applied by the actuators 116a, 116b to overcome the return means 2014, 3014 to deploy the shoes 114a, 114b remains substantially the same as the position of the shoe 114a, 114b changes. This is in contrast to return means such as helical coil springs or other springs obeying Hooke's Law, wherein the force required to overcome the resistance of the spring increases as the spring is extended. In the embodiments of FIGS. 8 and 9, the force required to retract the current collection shoe 114a, 114b in event of failure of the actuator 116a, 116b is preferably no greater, or only marginally greater than the retraction force applied by the constant force springs 2014, 3014 on the shoe current collection shoe 114a, 114b when the current collection shoe 114a, 114b is in the deployed position. This advantageously reduced the amount of force required by the actuator 116a, 116b to deploy the current collection shoe 114a, 114b under normal operation.

It is noted that the retraction means discussed in relation to FIGS. 8 and 9 are specifically envisaged to be combinable with the various arrangements discussed in relation to FIGS. 1A to 7B.

The above embodiments are provided as examples only—the scope of the invention is defined by the appended independent claims. Further aspects of the invention will be understood from the appended claims.

1. A rail vehicle current collection shoe apparatus comprising:
a current collection shoe for collecting current from a trackside charging contact;
an actuator configured to move the current collection shoe between a retracted position and a deployed position, the actuator mechanically linked to the current collection shoe via a first support member and a second support member;
wherein the second support member is connected to the first support member by a frangible joint; and
wherein the rail vehicle current collection shoe apparatus is configured to break at the frangible joint responsive to a shear force being applied to the current collection shoe and/or the first support member, the applied shear force exceeding a threshold shear force.

2. The rail vehicle current collection shoe apparatus of claim 1, wherein:
the first support member comprises a first electrically conducting portion;
the second support member comprises a second electrically conducting portion;
in use, the first electrically conducting portion and the second electrically conducting portion are in contact; and
the current collection shoe is electrically connected to the first electrically conducting portion.

3. The rail vehicle current collection shoe apparatus of claim 1, wherein:
the first support member comprises at least one first bore;
the second support member comprises at least one second bore, the second bore positioned so as to align with the first bore; and
the frangible joint comprises at least one elongate member, the elongate member positioned within the first and second bores and forming an interference fit with the first and second bores.

4. The rail vehicle current collection shoe apparatus of claim 2, wherein the elongate member is a bolt having a thread and at least one of the first bore and the second bore is threaded to correspond with the thread.

5. The rail vehicle current collection shoe apparatus of claim 2, wherein the elongate member, the first support member and the second support member are made from brass.

6. A rail vehicle current collection shoe apparatus comprising:
a current collection shoe for collecting current from a trackside charging contact; and
an actuator configured to move the current collection shoe between a retracted position and a deployed position, wherein the actuator is connected to the current collection shoe via one or more resiliently deformable members;
wherein the one or more resiliently deformable members are configured to deform under compression when the current collection shoe in the deployed position is brought into contact with a trackside charging contact.

7. The rail vehicle current collection shoe apparatus of claim 6, wherein the one or more resiliently deformable members are configured to deform under compression when the current collection shoe in the deployed position is brought into contact with a trackside charging contact such that the current collection shoe exhibits roll and/or pitch rotation relative to a rail vehicle direction of travel.

8. The rail vehicle current collection shoe apparatus of claim 6, wherein the one or more resiliently deformable members comprise four resiliently deformable members, each of the four resiliently deformable members positioned on an upper surface of the current collection shoe in use and proximate to a respective corner of the current collection shoe.

9. The rail vehicle current collection shoe apparatus of claim 6, wherein each of the one or more resiliently deformable members is made from an elastomeric material, optionally rubber.

10. A rail vehicle current collection shoe apparatus comprising:
a current collection shoe for collecting current from a trackside charging contact;
an actuator configured to move the current collection shoe between a retracted position and a deployed position;
a controller configured to, in use:
cause the actuator to move the current collection shoe to the deployed position, thereby pushing the current collection shoe against a trackside charging contact; and
while the current collection shoe remains in the deployed position:
monitor a force between the current collection shoe and the trackside charging contact;
cause the actuator to maintain the force between the current collection shoe and the trackside charging contact above a threshold force.

11. The rail vehicle current collection shoe apparatus of claim 10, wherein:
the actuator is a pneumatic actuator;
monitoring the force between the current collection shoe and the trackside charging contact comprises monitoring an air pressure of the pneumatic actuator.

12. The rail vehicle current collection shoe apparatus of claim 10, comprising one or more return means, the one or more return means comprising at least one of:
an air spring comprising a compressed air reservoir fluidly coupled to a pneumatic cylinder, the pneumatic cylinder comprising a piston connected to the current collection shoe, wherein the compressed air reservoir acts on the piston so as to bias the current collection shoe towards the retracted position;
a constant force wound spring;
a helical wire spring.

13. The rail vehicle current collection shoe apparatus of claim 10, further comprising one or more position sensors configured to monitor at least one of a position of the current collection shoe and an actuator stroke position.

14. The rail vehicle current collection shoe apparatus of claim 13, wherein the controller is configured to, in response to instructing the actuator to move the current collection shoe from the retracted position to the deployed position or instructing the actuator to move the current collection shoe from the deployed position to the retracted position:
determine, based on signals received from the one or more position sensors, an amount of time taken for the actuator to move the current collection shoe from the retracted position to the deployed position or from the deployed position to the retracted position.

15. The rail vehicle current collection shoe apparatus of claim 13, wherein the one or more position sensors comprise one or more limit switches configured to:
indicate when an actuator stroke corresponds to the current collection shoe being in the retracted position; and
indicate when the actuator stroke corresponds to the current collection shoe being in the deployed position.

16. The rail vehicle current collection shoe apparatus of claim 13, wherein the one or more position sensors comprise a sensor configured to measure an absolute actuator stroke position;
wherein the controller is configured to monitor the absolute actuator stroke position each time the current collection shoe makes contact with a trackside charging contact.

17. A rail vehicle current collection shoe apparatus comprising:
a current collection shoe for collecting current from a trackside charging contact;
an actuator configured to move the current collection shoe between a retracted position and a deployed position;
a first frame part affixed to and supporting the actuator; and
a second frame part configured to be affixed to a rail vehicle underframe;
wherein the first frame part is removably attached to the second frame part.

18. The rail vehicle current collection shoe apparatus of claim 17, wherein:
the first frame part comprises an extended portion;
the second frame part comprises a housing having an opening configured to receive the extended portion.

19. The rail vehicle current collection shoe apparatus of claim 17 further comprising a third frame part, wherein:
the second frame part is configured to be affixed to the rail vehicle underframe at a first position;
the third frame part is affixed to the configured to be affixed to a rail vehicle underframe at a second position, the second position displaced from the first position with respect to a rail vehicle direction of travel; and
the third frame part is removably attached to the first frame part.

20. A rail vehicle electrically conductive current collection shoe comprising:
a contact surface, the contact surface facing a trackside conductor in use;
a first end portion adjacent a middle portion, wherein the contact surface at the first end portion is at an angle relative to the contact surface at the middle portion, such that the thickness of the current collection shoe tapers towards a first end;
a first side extending away from the contact surface at the middle portion;
a first recess extending from a position in the first end portion, through at least a first part of the middle portion, to the first side.

21. The rail vehicle electrically conductive current collection shoe of claim 20 further comprising a second side extending away from the contact surface at the middle portion, the second side opposite the first side;
wherein the first recess further extends from the position in the first end portion, through at least a second part of the middle portion, to the second side; and
wherein the first recess is substantially symmetrical in a plane bisecting the contact surface parallel to a rail vehicle direction of travel.

22. The rail vehicle electrically conductive current collection shoe of claim 21, wherein the first recess defines a chevron shape in the contact surface.

23. The rail vehicle electrically conductive current collection shoe of claim 20 further comprising:
a second end portion adjacent the middle portion and opposite the first end portion, wherein the contact surface at the second end portion is at an angle relative to the contact surface at the middle portion, such that the thickness of the current collection shoe tapers towards a second end; and
a second recess extending from a position in the second end portion, through at least a third part of the middle portion, to the first side.

24. The rail vehicle electrically conductive current collection shoe of claim 23, wherein: the second recess further extends from the position in the second end portion, through at least a fourth part of the middle portion, to the second side; and
the second recess is substantially symmetrical in the plane bisecting the contact surface parallel to the rail vehicle direction of travel.

25. The rail vehicle electrically conductive current collection shoe of claim 24, wherein the second recess defines a chevron shape in the contact surface.

26. A rail vehicle current collection shoe apparatus comprising the rail vehicle electrically conductive current collection shoe of claim 20.

27. A rail vehicle current collection shoe apparatus comprising:
a current collection shoe for collecting current from a trackside charging contact;
an actuator configured to move the current collection shoe between a retracted position and a deployed position; and
a return means configured to bias the current collection shoe to the retracted position;
wherein the return means is configured to exert a substantially constant return force on the current collection shoe throughout a range of motion of the current collection shoe between the retracted and deployed positions.

28. The rail vehicle current collection shoe apparatus of claim 27, wherein the return means comprises a pneumatic cylinder and a piston which divides an interior of the pneumatic cylinder into a first side and a second side, wherein the second side is fluidly connected to an air reservoir, further wherein a volume of the air reservoir is larger than a volume of the pneumatic cylinder, optionally wherein the volume of the air reservoir is at least ten times larger than the volume of the pneumatic cylinder.

29. The rail vehicle current collection shoe apparatus of claim 28, wherein the actuator is a pneumatic actuator comprising an actuator cylinder having a piston which divides an interior of the actuator cylinder into a first actuator cylinder side and a second actuator cylinder side, wherein pressurisation of the first actuator cylinder side relative to the second actuator cylinder side causes deployment of the current collection shoe, wherein the second actuator cylinder side is fluidly connected to the air reservoir.

30. The rail vehicle current collection shoe apparatus of claim 27, wherein the return means comprises a constant force spring device comprising a strip of resilient material formed into a coiled configuration, further wherein a distal end of the strip of resilient material is fixed to the current collection shoe, such that the strip of resilient material unwinds as the current collection shoe is deployed.

31. A rail vehicle comprising the rail vehicle current collection shoe apparatus of claim 1.
